(19) United States
(12) Patent Application Publication
(10) Pub. No.: US 2019/0021459 A1
(43) Pub. Date: Jan. 24, 2019

(54) SHEET SHAPED DIAMOND INLAY JEWELRY

(71) Applicant: Shenzhen Y&M Jewelry Co., Ltd., Shenzhen (CN)

(72) Inventor: Tianwei Lin, Shenzhen (CN)

(21) Appl. No.: 15/782,848

(22) Filed: Oct. 13, 2017

(30) Foreign Application Priority Data
Jul. 24, 2017 (CN) 201710607223.8

(51) Int. Cl. A44C 17/04; A44C 17/02

(52) U.S. Cl. CPC A44C 17/04; G02C 11/02; A44C 17/02

(57) ABSTRACT

A sheet shaped diamond basically has no fire due to the property of its structure, and a computerized numerical control (CNC) technology is used to form a reflective sheet in a shape corresponding to the shape of the sheet shaped diamond for simulating a facet of a diamond pavilion, and cut a facet with a reflection effect, and the reflective sheet of the facet is inlaid to the bottom of the sheet shaped diamond and integrated with the sheet shaped diamond as a whole. Under natural light, the diamond will produce significant diamond fire and emit unparallel bright light, so that a plain rose cut sheet shaped diamond can give a visual effect just like a real stone, so as to improve the ornamental effect and economic value of the sheet shaped diamond.

### CROSS-REFERENCE TO RELATED APPLICATIONS

This present invention claims the benefit of Chinese Patent Application No. 201710607223.8, filed on Jul. 24, 2017; the contents of which are hereby incorporated by reference.

### FIELD OF INVENTION

The present invention relates to jewelries, in particular to a sheet shaped diamond inlay jewelry.

### BACKGROUND OF INVENTION

### 1. Description of the Related Art

Due to the material of stones, most rose cut diamonds available in the market are sheet shaped and flat bottomed, so that they are just plain diamonds without fire and look like a piece of glass, and such diamonds are seldom used for making jewelry, and almost no body cares for such diamonds even after they are made into jewelry.

2. Summary of the Invention

In view of the aforementioned problem, the present invention discloses a sheet shaped diamond inlay jewelry, comprising: a sheet shaped diamond without a diamond pavilion, and a reflective sheet simulating the diamond pavilion, and the sheet shaped diamond being inlaid on the reflective sheet, and the reflective sheet having a shape corresponding to the shape of the sheet shaped diamond.

Wherein, the sheet shaped diamond is a flat bottomed diamond, and the bottom of the sheet shaped diamond is a planar surface.

Wherein, the sheet shaped diamond is comprised of a crown and a girdle, and a table is disposed above the crown, and a bottom is disposed under the girdle, and the reflective sheet is disposed under the bottom.

Wherein, a cavity is formed between the sheet shaped diamond and the reflective sheet, and the reflective sheet simulating the diamond pavilion has a reflective surface simulating a facet of the diamond pavilion, and the reflective surface is disposed in the cavity, and the reflective surface and the bottom of the sheet shaped diamond jointly constitute an inner wall surface of the cavity.

Wherein, the cavity is substantially in a conical shape, and the reflective surface is a tapered surface of the conical cavity, and the center point of the reflective sheet is the vertex of the conical cavity, and the bottom of the sheet shaped diamond is the bottom of the conical cavity, and the reflective surface is outwardly and radially extended from the center point of the reflective sheet.

Wherein, the reflective surface is a metal reflective surface, and the reflective surface projected onto a horizontal surface is substantially in a triangular and/or sector shape.

Wherein, there are two or more reflective surfaces, and the included angle between any two adjacent reflective surfaces falls within a range of 120°˜140°.

The sheet shaped diamond inlaid jewelry further comprises a base, and the reflective sheet is inlaid on the base.

Wherein, the base is a frame, and the reflective sheet in inlaid into the frame, and the sheet shaped diamond is inlaid on the reflective sheet, and a portion of the sheet shaped diamond is protruded from the frame, and a second metal reflective surface is disposed on the front side of the frame, and the second reflective surface projected onto a horizontal surface is substantially in a triangular or sector shape.

Wherein, the frame has a plurality of paws for fixing the sheet shaped diamond, and the paws are disposed around the sheet shaped diamond.

In the present invention, a computerized numerical control (CNC) technology, a computerized numerical control (CNC) technology is used to form a reflective sheet in a shape corresponding to the shape of the sheet shaped diamond for simulating a facet of a diamond pavilion, and cut a facet with a reflection effect, and the reflective sheet of the facet is inlaid to the bottom of the sheet shaped diamond and integrated with the sheet shaped diamond as a whole. Under natural light, the diamond will produce significant diamond fire and emit unparallel bright light, so that a plain rose cut sheet shaped diamond can give a visual effect just like a real stone, so as to improve the ornamental effect and economic value of the sheet shaped diamond.

### BRIEF DESCRIPTION OF THE DRAWINGS

FIG. 1 is a front view of a sheet shaped diamond inlay jewelry of the present invention;

FIG. 2 is a rear view of a sheet shaped diamond inlay jewelry of the present invention;

FIG. 3 is a left side view of a sheet shaped diamond inlay jewelry of the present invention;

FIG. 4 is a right side view of a sheet shaped diamond inlay jewelry of the present invention;

FIG. 5 is a bottom view of a sheet shaped diamond inlay jewelry of the present invention;

FIG. 6 is a top view of a sheet shaped diamond inlay jewelry of the present invention;

FIG. 7 is a perspective view of a sheet shaped diamond inlay jewelry of the present invention;

FIG. 8 is an exploded view of a sheet shaped diamond inlay jewelry of the present invention;

FIG. 9 is a schematic view of a frame and a reflective sheet of a sheet shaped diamond inlay jewelry of the present invention; and

FIG. 10 is a bottom exploded view of a sheet shaped diamond inlay jewelry of the present invention.

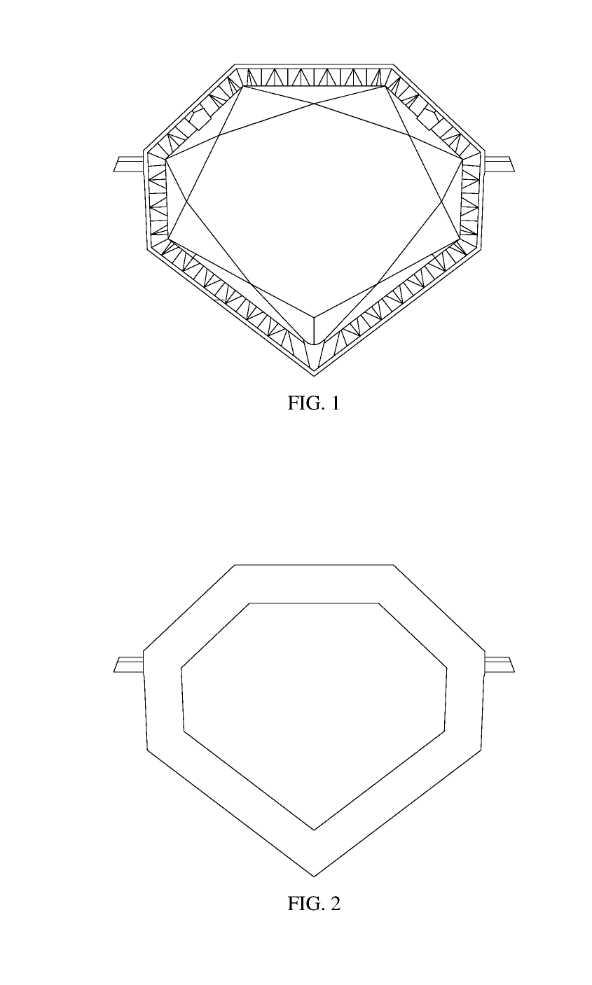

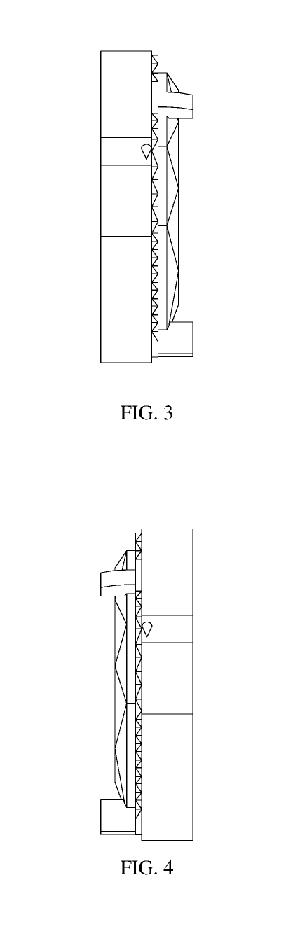

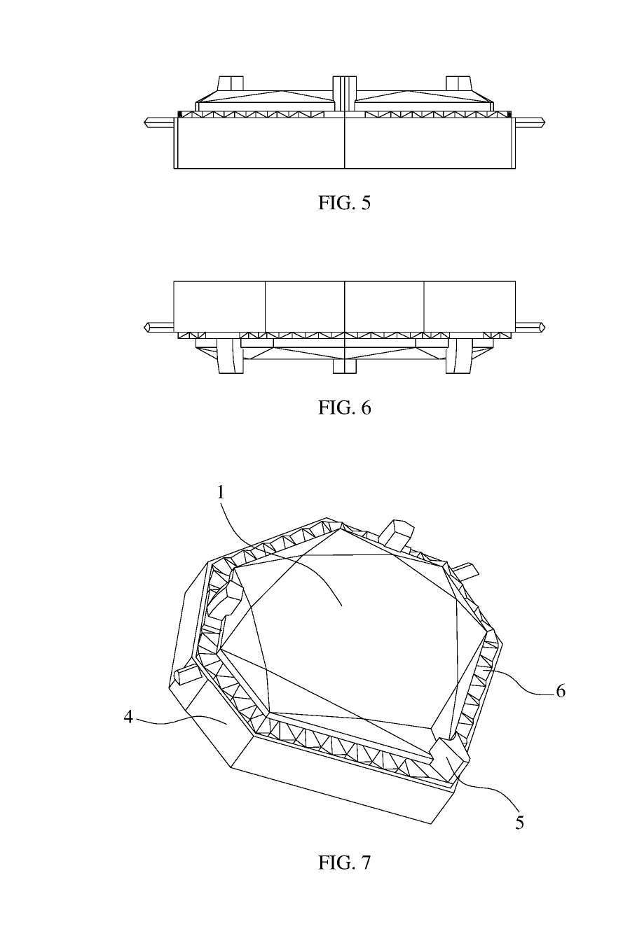

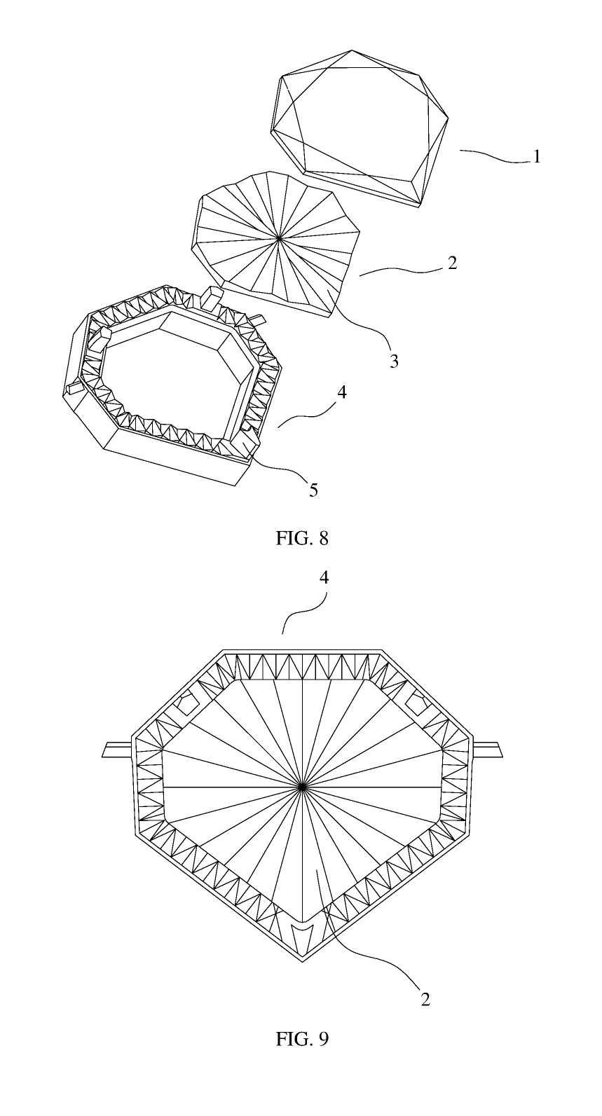

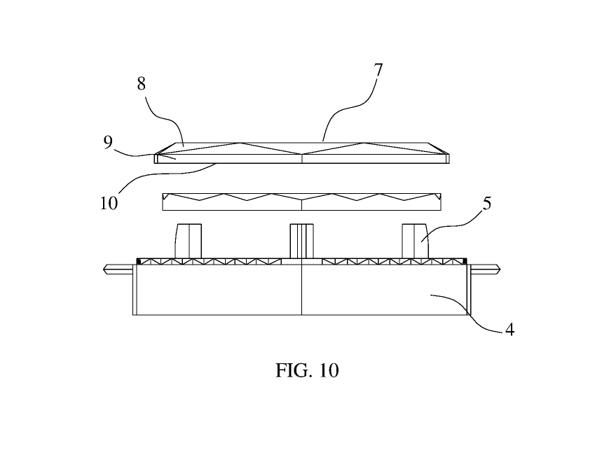

### DESCRIPTION OF THE PREFERRED EMBODIMENTS

The above and other objects, features and advantages of this disclosure will become apparent from the following detailed description taken with the accompanying drawings.

There are many thin sheet shaped diamonds available in the market, and such diamonds do not have the pavilion of a regular conical diamond or the diamond fire of a regular diamond. Due to the property of the sheet shaped diamond having no fire, the present invention designs a sheet shaped diamond inlay jewelry comprising a sheet shaped diamond 1 without a diamond pavilion and a reflective sheet simulating the diamond pavilion 2, and the sheet shaped diamond 1 is inlaid on the reflective sheet 2, and the reflective sheet 2 has a shape corresponding to the shape of the sheet shaped diamond 1. Since the sheet shaped diamond 1 is sheet shaped and does not have the pavilion of a regular diamond, therefore the sheet shaped diamond 1 has no fire like the regular diamond. In view of the sheet shaped diamond 1 having no pavilion, the present invention adds a diamond pavilion like structure to the sheet shaped diamond 1 by inlaying the sheet shaped diamond 1 on a reflective sheet simulating the diamond pavilion 2 and uses the light reflection effect of the reflective sheet 2 for the light reflection effect of the pavilion of the regular diamond, so that the whole sheet shaped diamond jewelry has a diamond fire effect, and the sheet shaped diamond 1 without fire can have the fire of a regular diamond. In the meantime, the reflective sheet 2 has a shape corresponding to the shape of the sheet shaped diamond 1, and such correspondence is similar to the correspondence between the diamond pavilion and other remaining parts of the structure of the diamond. Like the whole structure of a diamond, the parts must be corresponsive to each other before the whole diamond achieves a better optical effect. As to the people having ordinary skill in the art, such correspondence of the sheet shaped diamond 1 having a basic diamond facet structure at the upper half allows the sheet shaped diamond 1 can be designed to one with a diamond pavilion structure in the shape of the corresponsive reflective sheet 2. When the sheet shaped diamond 1 is a circular sheet shaped, the corresponding reflective sheet simulating the diamond pavilion 2 is naturally designed to be a circular reflective sheet 2. When the sheet shaped diamond 1 is in a polygonal shape, the corresponding reflective sheet simulating the diamond pavilion 2 is naturally designed to be a polygonal reflective sheet 2, so as to correspond to the sheet shaped diamond 1. Now, the sheet shaped diamond 1 and the reflective sheet 2 naturally have the same size or specification, so that both of the sheet shaped diamond 1 and the reflective sheet 2 have the shape corresponding to the whole structure of the diamond in order to achieve the structural characteristics of a regular simulated conical diamond and the required diamond fire effect.

Preferably, the sheet shaped diamond 1 is a flat bottomed diamond, and the bottom 10 of the sheet shaped diamond 1 is a planar surface. The whole sheet shaped diamond 1 is comprised of a crown 8 and a girdle 9, and a table 7 is disposed above the crown 8, and a bottom 10 is disposed under the girdle 9, and the reflective sheet 2 is disposed under the bottom 10. Due to the sheet shaped structure of the sheet shaped diamond 1, it is difficult to manufacture the sheet shaped diamond 1 to produce a regular diamond with the pyramid structure, and such sheet shaped diamond 1 is just a transparent stone similar to a piece of flat bottomed glass without any unique fire effect of the regular diamond, and such diamond is just low priced. In the present invention, a reflective sheet 2 is provided to substitute the pavilion of the regular diamond, and such structure has the reflection effect similar to that of a diamond pavilion. When the sheet shaped diamond 1 combined with the reflective sheet 2 is manufactured, it simply needs to manufacture the aforementioned structure acting as the pavilion of the regular diamond and then combined the structure with the reflective sheet 2 acting as the pavilion, so as to form a diamond similar to a regular diamond and having the diamond fire. Basically, the pavilion of a regular diamond is comprised of a girdle and a crown, and the top of the diamond is the table. Therefore, the sheet shaped diamond 1 simply requires a crown and a girdle similar to those of the regular diamond, and combines a reflective sheet 2 acting as the pavilion to form a novel diamond structure with diamond fire.

Preferably, a cavity is formed between the sheet shaped diamond 1 and the reflective sheet 2, and the reflective sheet simulating the diamond pavilion 2 has a reflective surface 3 simulating a facet of the diamond pavilion facet, and the reflective surface 3 is disposed in the cavity, and the reflective surface 3 and the bottom 10 of the sheet shaped diamond 1 jointly constitute the inner wall surface of the cavity. Based on the aforementioned technical characteristics of the present invention, a reflective sheet 2 is added to substitute the pavilion of the sheet shaped diamond 1 without a pavilion structure, and the pavilion of a regular diamond is comprised of facets, so that the reflective sheet 2 used for substituting the regular diamond pavilion should have a corresponding reflective surface 3, wherein the reflective surface 3 is directly similar or equivalent to the facet of the regular diamond pavilion. People having ordinary skill in the art should know that the facet of the diamond pavilion and other facets of the diamond should be manufactured such that they are corresponsive to each other in order to achieve a better diamond fire effect, and each facet has a complicated relation of light reflection and refraction, and the best diamond fire effect can be achieved only under the effect of all facets. To achieve the best diamond fire effect, the present invention uses the reflective surface 13 in the manufacturing process to substitute the facet of the regular diamond pavilion, and the specific shape and structure should be matched with the facets of the sheet shaped diamond 1, and people having ordinary skill in the art may use such matching method or correspondence to design a reflective surface 3 with specific quantity, shape and structure, and the facet of the sheet shaped diamond 1 is used to substitute the facet of the diamond pavilion.

Preferably, the cavity is conical, and the reflective surface 3 constitutes a tapered surface of the conical cavity, and the center point of the reflective sheet 2 constitutes the vertex of the conical cavity, and the bottom 10 of the sheet shaped diamond 1 constitutes the bottom of the conical cavity, and the reflective surface 3 is radially extended to the outside from the center point of the reflective sheet 2. Therefore, the reflective surface 3 on the reflective sheet 2 is substantially conical and concavely formed thereon, so as to simulate the conical facet of the regular diamond pavilion facet. In a regular diamond, the pavilion is in a pyramid shape, and the tapered surface of the pyramid constitutes the facet of the diamond pavilion facet. Similarly, the reflective sheet 2 simulating the structure of the regular diamond pavilion is designed to be pyramid, and the reflective surface 3 on the reflective sheet 2 is designed to be a tapered surface of a pyramid, and the center point of the reflective sheet 2 is the vertex of the pyramid.

Preferably, the reflective surface 3 is a metal reflective surface, and the reflective surface 3 projected on a horizontal surface is substantially in a triangular and/or sector shape. As a jewelry, a precious metal may be used to manufacture the reflective sheet 2, and then the reflective sheet 2 is manufactured to form a bright metal reflective surface. In general, a metal has a special luster, so that the metal surface is bright, and the metal reflective surface so formed has a better light reflection effect. The metal reflective surface and the sheet shaped diamond 1 are combined, so that the diamond has a better fire through the light refraction and reflection. In addition, the manufactured reflective surface 3 is in the shape of the facet simulating the regular diamond pavilion, and this shape is usually in a triangular or sector shape when projected onto a horizontal surface. Therefore, the reflective surface 3 is distributed radially along the center point of the reflective sheet 2, and the reflective surface 3 is intersected at the center point.

Preferably, there are two or more reflective surfaces 3, and the included angle between any two adjacent reflective surfaces 3 falls within a range of 120°˜140°. The reflective surface 3 is used to simulate the facet of the regular diamond pavilion, so that the quantity is naturally plural, and the included angle between any two adjacent reflective surfaces 3 affects the angle of the light reflection and directly affect the fire of the diamond jewelry. In actual manufacturing an angle knife may be used to control the range of such angle.

Preferably, the sheet shaped diamond inlaid jewelry further comprises a base, and the reflective sheet 2 is inlaid on the base. The base is a structure for inlaying or fixing the reflective sheet 2 and the sheet shaped diamond 1. The base may be designed with the shape and structure according to those of the sheet shaped diamond 1, so that the base and the sheet shaped diamond 1 are corresponsive to each other to facilitate inlaying the sheet shaped diamond 1 and the reflective sheet 2. In the meantime, the base is preferably a frame 4, and the reflective sheet 2 is inlaid in the frame 4, and the sheet shaped diamond 1 is then inlaid on the reflective sheet 2, and a portion of the sheet shaped diamond 1 is protruded from the frame 4. In addition, the front side of the frame 4 has a second metal reflective surface 6, and the second metal reflective surface 6 projected onto a horizontal surface is substantially in a triangular and/or sector shape. In other words, the whole frame 4 may be made of a precious metal directly, and the surface of the precious metal is manufactured into a second metal reflective surface 6 similar to the facet of a diamond, and the second metal reflective surface 6 projected onto a horizontal surface is substantially in a triangular and/or sector shape. These second metal reflective surfaces 6 may be used to reflect the fire of the diamond, so that the whole jewelry is more dazzling and colorful.

Preferably, the frame 4 has a plurality of paws 5 for fixing the sheet shaped diamond 1, and the paws 5 are disposed around the sheet shaped diamond 1, and the quantity of paws 5 is preferably equal to three. With the design of three paws 5, the required fixing effect is achieved, and such quantity of paws will not affect the fire effect of the whole diamond jewelry.

In the present invention, a computerized numerical control (CNC) technology is used to form a reflective sheet in a shape corresponding to the shape of the sheet shaped diamond for simulating a facet of a diamond pavilion, and cut a facet with a reflection effect, and the reflective sheet of the facet is inlaid to the bottom of the sheet shaped diamond and integrated with the sheet shaped diamond as a whole. Under natural light, the diamond will produce significant diamond fire and emit unparallel bright light, so that a plain rose cut sheet shaped diamond can give a visual effect just like a real stone, so as to improve the ornamental effect and economic value of the sheet shaped diamond.

It is noteworthy that the up, down, left, right, front and rear position represent relative positions but not absolute positions, and they are used in the embodiments for the purpose of illustrating the technical characteristics of the invention, but not intended for limiting the scope of the invention.

While the invention has been described by means of specific embodiments, numerous modifications and variations could be made thereto by those skilled in the art without departing from the scope and spirit of the invention set forth in the claims.

What is claimed is:

1. A sheet shaped diamond inlay jewelry, comprising a sheet shaped diamond without a diamond pavilion, and a reflective sheet simulating the diamond pavilion, and the sheet shaped diamond being inlaid on the reflective sheet, and the reflective sheet having a shape corresponding to the shape of the sheet shaped diamond.

2. The sheet shaped diamond inlay jewelry of claim 1, wherein the sheet shaped diamond is a flat bottomed diamond, and the bottom of the sheet shaped diamond is a planar surface.

3. The sheet shaped diamond inlay jewelry of claim 2, wherein the sheet shaped diamond is comprised of a crown and a girdle, and a table is disposed above the crown, and a bottom is disposed under the girdle, and the reflective sheet is disposed under the bottom.

4. The sheet shaped diamond inlay jewelry of claim 1, further comprising a cavity formed between the sheet shaped diamond and the reflective sheet, and the reflective sheet simulating the diamond pavilion having a reflective surface simulating a facet of the diamond pavilion, and the reflective surface being disposed in the cavity, and the reflective surface and the bottom of the sheet shaped diamond jointly constituting an inner wall surface of the cavity.

5. The sheet shaped diamond inlay jewelry of claim 2, further comprising a cavity formed between the sheet shaped diamond and the reflective sheet, and the reflective sheet simulating the diamond pavilion having a reflective surface simulating a facet of the diamond pavilion, and the reflective surface being disposed in the cavity, and the reflective surface and the bottom of the sheet shaped diamond jointly constituting an inner wall surface of the cavity.

6. The sheet shaped diamond inlay jewelry of claim 3, further comprising a cavity formed between the sheet shaped diamond and the reflective sheet, and the reflective sheet simulating the diamond pavilion having a reflective surface simulating a facet of the diamond pavilion, and the reflective surface being disposed in the cavity, and the reflective surface and the bottom of the sheet shaped diamond jointly constituting an inner wall surface of the cavity.

7. The sheet shaped diamond inlay jewelry of claim 4, wherein the cavity is substantially in a conical shape, and the reflective surface forms a tapered surface of the conical cavity, and the center point of the reflective sheet forms the vertex of the conical cavity, and the bottom of the sheet shaped diamond forms the bottom of the conical cavity, and the reflective surface is outwardly and radially extended from the center point of the reflective sheet.

8. The sheet shaped diamond inlay jewelry of claim 7, wherein the reflective surface is a metal reflective surface, and the reflective surface projected onto a horizontal surface is substantially in a triangular and/or sector shape.

9. The sheet shaped diamond inlay jewelry of claim 8, wherein the reflective surface comes with a quantity of more than two, and the included angle between any two adjacent reflective surfaces falls within a range of 120°˜140°.

10. The sheet shaped diamond inlay jewelry of claim 7, further comprising a base, and the reflective sheet being inlaid on the base.

11. The sheet shaped diamond inlay jewelry of claim 8, further comprising a base, and the reflective sheet being inlaid on the base.

12. The sheet shaped diamond inlay jewelry of claim 9, further comprising a base, and the reflective sheet being inlaid on the base.

13. The sheet shaped diamond inlay jewelry of claim 10, wherein the base is a frame, and the reflective sheet in inlaid into the frame, and the sheet shaped diamond is inlaid on the reflective sheet, and a portion of the sheet shaped diamond is protruded from the frame, and a second metal reflective surface is disposed on the front side of the frame, and the second reflective surface projected onto a horizontal surface is substantially in a triangular or sector shape.

14. The sheet shaped diamond inlay jewelry of claim 11, wherein the base is a frame, and the reflective sheet in inlaid into the frame, and the sheet shaped diamond is inlaid on the reflective sheet, and a portion of the sheet shaped diamond is protruded from the frame, and a second metal reflective surface is disposed on the front side of the frame, and the second reflective surface projected onto a horizontal surface is substantially in a triangular or sector shape.

15. The sheet shaped diamond inlay jewelry of claim 12, wherein the base is a frame, and the reflective sheet in inlaid into the frame, and the sheet shaped diamond is inlaid on the reflective sheet, and a portion of the sheet shaped diamond is protruded from the frame, and a second metal reflective surface is disposed on the front side of the frame, and the second reflective surface projected onto a horizontal surface is substantially in a triangular or sector shape.

16. The sheet shaped diamond inlay jewelry of claim 13, wherein the frame has a plurality of paws for fixing the sheet shaped diamond, and the paws are disposed around the sheet shaped diamond.
